(19) United States
(12) Patent Application Publication
(10) Pub. No.: US 2005/0193852 A1
(43) Pub. Date: Sep. 8, 2005

(54) Transmission system with increased power density

(76) Inventors: Clark VanTine Cooper, Glastonbury, CT (US); Charles Joseph Isabelle, Barkhamsted, CT (US); Harsh Vinayak, Meriden, CT (US); Jules Gene Kish, Milford, CT (US); Robin Mihekun Miller, Ellington, CT (US); Glenn N. Levasseur, Colchester, CT (US); Edward J. Karedes, Cheshire, CT (US); Anthony G. Chory, Trumbull, CT (US); Stephen Robert Sammataro, Madison, CT (US); Michael F. Mullen, Cheshire, CT (US); Bruce D. Hansen, Shelton, CT (US); Mark W. Davis, Vernon, CT (US)

Correspondence Address: CARLSON, GASKEY & OLDS, P.C., 400 WEST MAPLE ROAD, SUITE 350, BIRMINGHAM, MI, 48009, US

(21) Appl. No.: 10/795,137

(22) Filed: Mar. 5, 2004

(51) Int. Cl. F16H 57/08

(52) U.S. Cl. 74/462

(57) ABSTRACT

A transmission provides for the application of higher design allowables in bending, pitting, and scoring, as enabled by surface-engineering (SE) processes such as isotropic superfinishing and Me-DLC coating to effect increases in the power density of transmission systems.

### BACKGROUND OF THE INVENTION

The present invention relates to a gearbox system, and more particularly to a rotary wing transmission with surface engineered transmission components, which provide increased power density.

In fixed wing aircraft, it is common to replace engines with more powerful engines to provide increased performance. However, for rotary wing aircraft such replacement may not be feasible since additional power from higher powered engines must pass through a main rotor transmission. The main rotor transmission has an upper limit to the amount of power that can be absorbed. The transmission then becomes the limiting factor to the provision of adding additional power through the incorporation of higher power engines. Such limitations apply to other vehicles such as land and marine vehicles in which a transmission becomes the limiting factor to increasing the amount of power that can be absorbed.

Main rotor transmissions are relatively complex power gear trains with limitations in the amount of horsepower that the power train can absorb. The amount of power that a transmission can effectively handle is typically referred to as power density. Redesigning a main rotor transmission to accommodate even moderate increases in power, such as from incorporating higher power engines, may be a relatively expensive undertaking.

Accordingly, it is desirable to provide increased power density through a rotary wing transmission system while minimizing the redesign of related systems.

### SUMMARY OF THE INVENTION

The transmission system according to the present invention provides for the application of higher design allowables in bending, pitting, and scoring, as enabled by surface-engineering (SE) processes such as isotropic superfinishing and Me-DLC coating, to effect increases in the power and torque density of transmission systems. One such increase in power density is achieved through an increase in power throughput with no attendant increase in system weight. A second such increase in system power density is achieved through reductions in system weight with no decrease in power throughput.

The present invention therefore provides an increased power density through a rotary wing transmission system while minimizing the redesign of related systems.

### BRIEF DESCRIPTION OF THE DRAWINGS

The various features and advantages of this invention will become apparent to those skilled in the art from the following detailed description of the currently preferred embodiment. The drawings that accompany the detailed description can be briefly described as follows:

FIG. 1 is a general schematic view of an exemplary rotary wing aircraft embodiment for use with the present invention;

FIG. 2, is a flow chart illustrating redesign of a gear mesh according to the present invention due to higher contact stress from SE;

FIG. 3A is schematic sectional view of a SE main bevel gear which provides increased power throughput;

FIG. 3B is schematic sectional view of a SE main bevel gear which provides decreased weight without reduction in power throughput;

FIG. 4 is schematic sectional view of a SE shaft arrangement utilized within a transmission of FIG. 1; and

FIG. 5 is a general schematic view of an exemplary marine embodiment for use with the present invention.

### DETAILED DESCRIPTION OF THE PREFERRED EMBODIMENT

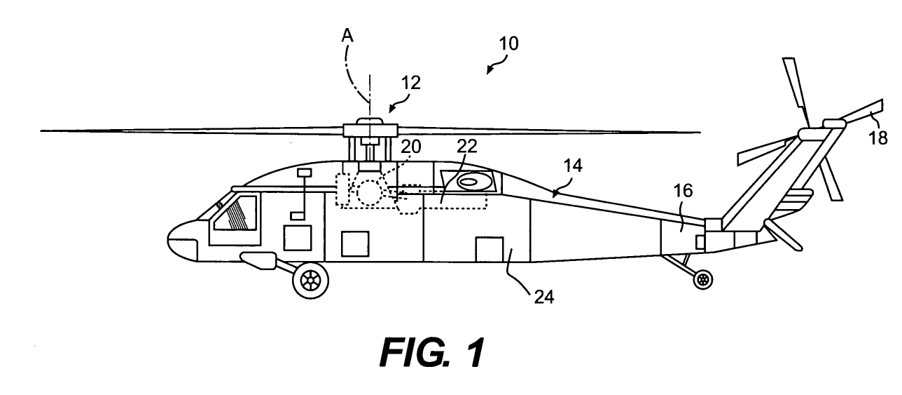

FIG. 1 schematically illustrates a rotary wing aircraft 10 having a main rotor assembly 12. The aircraft 10 includes an airframe 14 having an extending tail 16 which mounts an anti-torque rotor 18. The main rotor assembly 12 is driven through a main rotor transmission (illustrated schematically at 20) by one or more engines 22. Although a particular helicopter configuration is illustrated in the disclosed embodiment, other machines such as turbo-prop aircraft, tilt-wing aircraft, wind turbines, ground vehicles, marine vehicles and the like will also benefit from the present invention.

The typical design methodology for gear components within a gearbox system such as an aircraft transmission 20 balances the pitting and bending durability, such that both pitting and bending stresses are at or near their design allowable. Design allowable is a material constant that represents the stress to provide for unlimited component lives. The process for establishing the design allowable varies, but one scheme determines the stress that causes failure in 10⁹ cycles, from which a stress equal to 3× the standard deviation, 3σ, is subtracted to result in a design philosophy in which “mean minus three sigma” is adopted as the design stress or design allowable. An ideal gear design is one in which both the bending and the pitting stresses are at the design allowable. Because failures in bending can be catastrophic, pitting failures are considered to be non-catastrophic and detectable, gear designers often design to an additional margin of safety in bending.

It has been recognized that changes in materials or processes, for example, which result in a higher design allowable in pitting can be utilized in an existing design to impart enhanced lifetimes to failure and to impart an additional margin of safety in pitting to match that which typically exists for bending. Such an application is termed a strict retrofit. Frequently in retrofit applications, other components then become the limiting factor for power density.

Greater pitting and/or bending design allowables effect a transmission system that possesses greater power density through (1) weight reduction at constant power throughput and/or (2) higher power throughput with no change or a modest reduction in system weight. This application of higher design allowables is termed a derivative design.

The application of higher design allowables in bending, pitting, and scoring, as enabled by surface-engineering (SE) processes such as isotropic superfinishing and Me-DLC coating, the effect increases in power density of transmission systems.

The SE process of Me-DLC coating produces a significant enhancement in the surface-pitting durability and scoring resistance of power-transmission gears. Another SE process known as isotropic superfinishing (ISF) enhances the scoring resistance of power-transmission gears. ISF enhances both bending and pitting durability of processed gears compared to baseline performance. The SE process for use with the present invention enable higher case hardness without degraded core strength and use of higher core strength materials. It should be understood that a multiple of SE processes will benefit from the present invention.

The system-level benefits that SE provides take the form of (1) strict component retrofit; (2) derivative transmission redesign; and (3) new transmission design. The enhancements in pitting, bending, and scoring design allowables enable retrofit, derivative, or new transmission designs. The latter two approaches result in higher system-level power density, while the first approach increases component- and system-level durability and reliability through direct replacement of components with SE components.

A derivative transmission design utilizes an existing transmission as the basis, but is subject to certain design constraints. For example only, the general footprint, fore-aft location, and shaft centerlines of the transmission typically remain fixed, such that the center of gravity and system integration into the remainder of the aircraft is unaffected.

Additional latitude is afforded derivative transmission design through variation of gear tooth facewidth. Capitalization on decreased gear face width translates the location of the gear load centroid to control resulting gear shaft reaction moments and equalize resulting bearing lives. Mesh efficiency is improved significantly with surface engineering, allowing for decreased temperature rise in the oil even at increased power. That is, the system runs cooler with an existing lubricant processing system. By reducing gear face width, bearings may be repositioned relative the gear load center and or increase the envelope for bearing design changes to increase bearing load capacity.

Utilization of the higher pitting, bending, and scoring design allowables effect increases in power density without an attendant increase in system weight. The power throughput of an existing transmission system is increased to meet new requirements without the expense and time required for a new transmission design. Studies conclude by Applicant enabled enhancements in the stated design allowables, which increase the power throughput of an existing rotorcraft transmission system by 16% while reducing the system weight by 2%.

Capitalization on the decreased gear face width translate the location of the gear load centroid to control resulting gear shaft reaction moments and equalize resulting bearing lives. The decrease in frictionally generated heat load, enabled by the surface-engineered gears, decreases the demand on and size of other system components, such as heat exchangers and oil pumps, and decreases the volume of oil required for thermal management. Such a decrease in demand on ancillary systems produce further increases in system power density.

Another derivative design is the utilization of the higher design allowables to reduce component weight while maintaining constant power throughput. As noted, the facewidth of gear components may be reduced to capitalize on these enhancements without any decrease in system durability or reliability.

Integration of these technologies and approaches enables a paradigm shift in the design of transmission systems to yield higher power densities in a new design. In a new design, few if any constraints apply to the design of gears and bearings, and system components may be designed on the basis of the enhancement in properties and allowables that are imparted by the SE process. The paradigm shift embodies the re-balancing of contact and bending stresses to achieve equal or nearly equal durability in bending and pitting, which results in gears with smaller diameters and decreased tooth counts for increased torque throughputs.

Increases in system power density place increased demands on thrust surfaces as radial and torque stresses increase, temperatures increase, and more system deflection may occur. As such, the entire system is analyzed for limitations. Gear mesh optimization sets the maximum power situation. Increasing the power throughput on a mesh with a thrust factor enables tuning of the mesh to maximize bearing life through analysis of resulting loads.

Optimization of system power densities require increased capability from other system components, including, but not limited to bearings, shafts, carriers, and casings. The components and factors involved with the methodology include materials, surface engineering, lubrication, and design engineering.

A designer typically sizes a gear pair by calculating certain load and design dependent parameter values and comparing them against the corresponding design allowables previously obtained through rigorous experiments. The three prime parameters that are used for gear design are 1) Gear teeth bending stress at the root, 2) Teeth surface contact stress and 3) Gear teeth scoring index. All three are dependent on gear tooth geometry and applied load.

In general the gear tooth bending stress decreases in response to decreasing the number of teeth on a gear if the overall gear size is not to be changed. Conversely, the tooth contact stress increases on decreasing the number of teeth. Both bending and contact stresses increase on decreasing the overall size of the gear. The aim of a gear designer is to optimize the size and number of teeth on each gear in a mesh such that both the bending and contact stresses are just within the respective design allowable values.

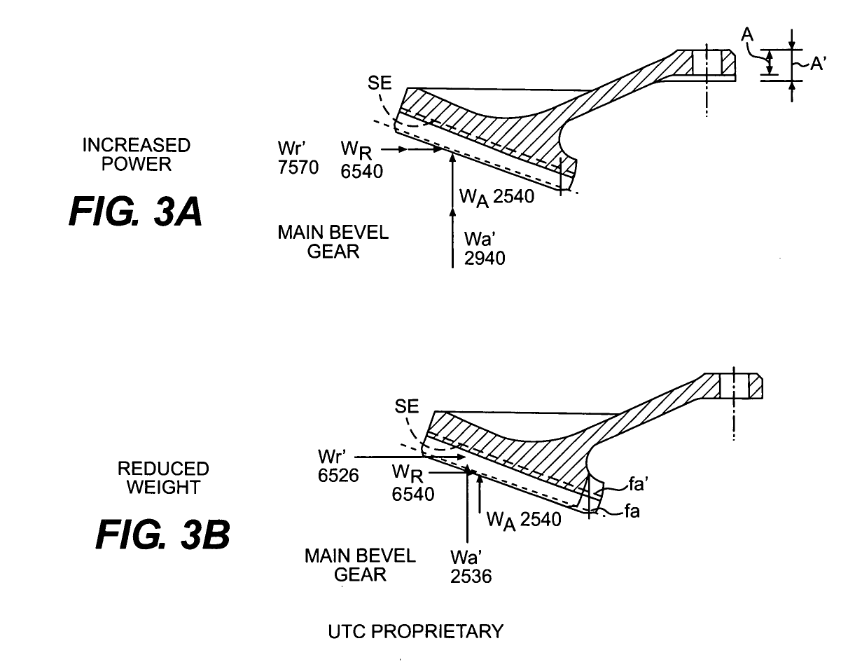

As one of the design allowables are raised, for example only, the contact design allowable is increased by application of surface engineering, then the designer can: a) allow more power through the existing gear mesh if the contact stresses are the critical design characteristics (FIG. 3A); b) Reduce the width of the gear to obtain weight savings while still allowing the same power through the mesh (FIG. 3B); or c) Redesign the gear mesh to take advantage of the increase in the allowable contact stresses and optimize the gear mesh for the particular application.

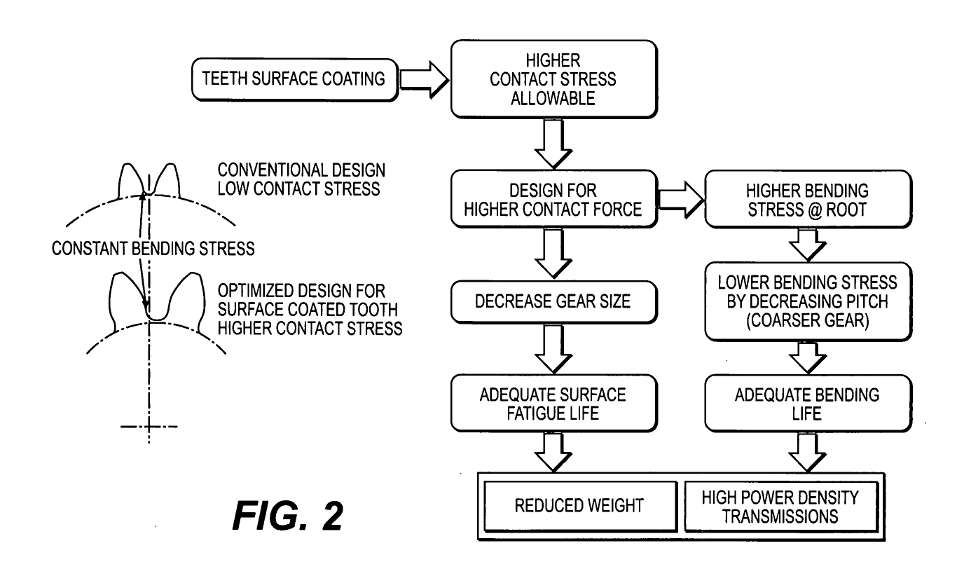

Referring to FIG. 2, the redesign of gear mesh according to the present invention to take advantage of the increase in the allowable contact stresses provides a paradigm shift in gear design. Preferably the paradigm shift is affected by decreasing the gear size such that the now elevated contact stress is just under the new design allowable (also elevated due to surface engineering) and by decreasing the number of teeth such that the bending stress is below its design allowable. Doing so substantially decreases the overall weight of the geared transmission or speed changer and consequently increases the power and torque density of the gear mesh.

Referring to FIGS. 3A and 3B, application of a SE processes permits a main bevel gear 30A, 30B such as that common to a rotary-wing transmission achieve greater power throughput (FIG. 3A) or a reduced weight with the same power throughput capability (FIG. 3B). FIG. 3A illustrates that the increased power throughput due to SE teeth is accommodated by an increase in the arm A to a greater thickness A′ while the remainder of the gear 30A retains the same outer dimensional envelope. FIG. 3B illustrates that the same power throughput is achieved with reduced weight due to SE teeth by reducing the face width Fa at an inner diameter of the gear 30B from Fa to Fa′ resulting in a decrease in gear weight.

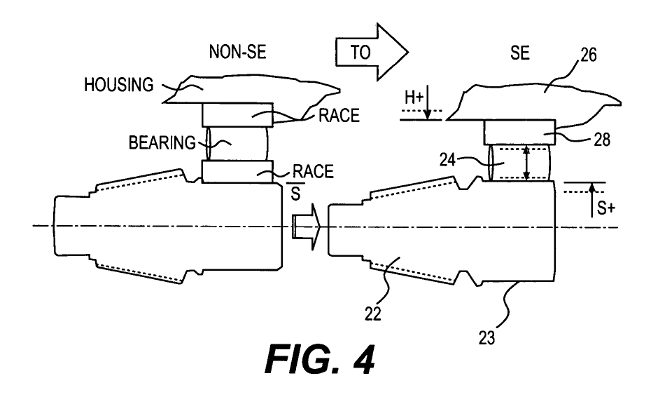

Referring to FIG. 4, application of a SE processes permits a shaft 22 to be utilized as a bearing inner race. That is, the shaft 22 includes a SE surface 23 which permit an increase in shaft size S+ due to the elimination of a bearing inner race. The elimination of the inner race permit a commensurate upsizing of bearing elements 24 to B+ and an upsizing of a housing 26 to H+ to support an outer race 28. The elimination of an inner race through utilization of the SE shaft 22 provides for increased load factors within the same component envelope. Moreover, benefits provided by a shaft with enlarged diameter S+provide greater bending and torque-transmission capability, a larger bearing element for greater load capability or increased life, and increased housing section thickness for greater strength.

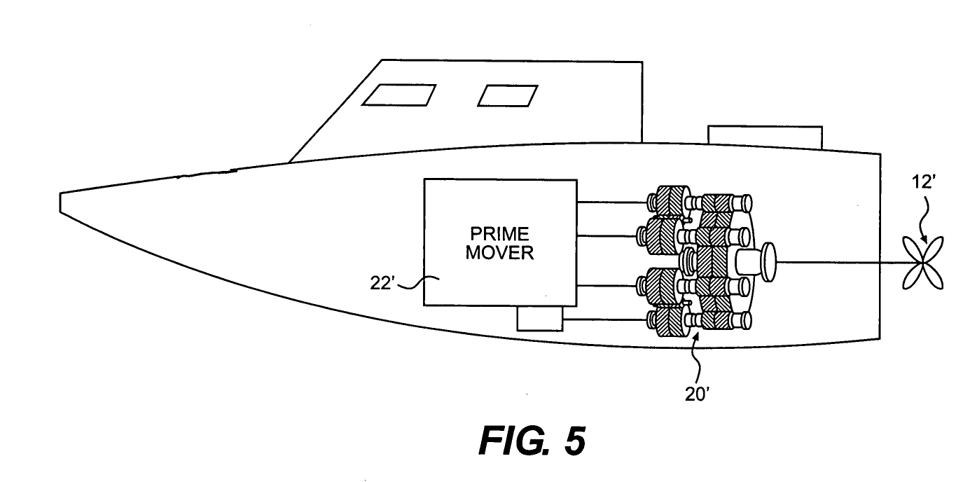

Referring to FIG. 5, application of this methodology to the speed reducer design to any vessel employing a prime mover 22′ and a slower speed propulsor/propeller 12 through a transmission 20′, is to increase the available vessel weight attributable to the vessels payload carrying capability. In a marine vessel examples of this increased payload capability would be an increase in the potential cargo in a merchant marine vessel, or an increase in the weapons payload that could be carried in a military marine vessel. Similarly, for an aircraft or airframe, whether military or commercial, similar improvements in payload carrying capability could be realized using the gear surface improvement technology taught in this invention.

The foregoing description is exemplary rather than defined by the limitations within. Many modifications and variations of the present invention are possible in light of the above teachings. The preferred embodiments of this invention have been disclosed, however, one of ordinary skill in the art would recognize that certain modifications would come within the scope of this invention. It is, therefore, to be understood that within the scope of the appended claims, the invention may be practiced otherwise than as specifically described. For that reason the following claims should be studied to determine the true scope and content of this invention.

1. A transmission system comprising:
a first transmission component with a surface-engineered surface; and
a second transmission component engaged with said first transmission component at an interface, said interface operable to provide an increased power density.

2. The transmission system as recited in claim 1, wherein said surface-engineered processes comprises an isotropic superfinishing.

3. The transmission system as recited in claim 1, wherein said surface-engineered processes comprises an Me-DLC coating.

4. The transmission system as recited in claim 1, wherein said interface comprises a gear mesh.

5. The transmission system as recited in claim 4, wherein said gear mesh comprises said surface engineered process.

6. The transmission system as recited in claim 1, wherein said first transmission component comprises a shaft and said second transmission component comprises a bearing element.

7. The transmission system as recited in claim 6, wherein said bearing element is engaged between said shaft and an outer race.

8. The transmission system as recited in claim 1, wherein said transmission system comprises a rotary wing transmission.

9. A transmission system comprising:
a shaft with a surface-engineered surface;
a bearing element engaged with said surface engineered surface;
an outer race engaged with said bearing element; and
a housing which supports said outer race.

10. The transmission system as recited in claim 9 wherein said surface-engineered processes comprises an isotropic superfinishing.

11. The transmission system as recited in claim 9 wherein said surface-engineered processes comprises an Me-DLC coating.

12. A method of designing a gear system comprising the steps of:
(1) elevating a gear contact stress value and a bending stress value through a surface engineering process to provide an increased power density;
(2) decreasing a size of a gear in relation to the gear contact stress value of said step (1) such that the size of the gear is limited by the gear contact stress value of said step (1); and
(3) decreasing a number of teeth of the gear in relation to the bending stress value of said step (1) such that the number of teeth of the gear is limited by the bending stress value of said step (1).

13. A method as recited in claim 12, wherein said step (1) further comprises:
re-balancing the contact stress value and the bending stress value to achieve nearly equal durability in bending and pitting.

14. A method as recited in claim 12, wherein said step (3) further comprises:
(a) reducing a gear face width of each of the number of teeth of the gear.

15. A method as recited in claim 14, further comprising thee steps of:
translating a location of a gear load centroid in relation to said step (a) to equalize gear shaft reaction moments.

16. A method as recited in claim 12, further comprising thee steps of:
maintaining a center of gravity of the gear.
